(19) United States
(12) Patent Application Publication
(10) Pub. No.: US 2013/0262174 A1
(43) Pub. Date: Oct. 3, 2013

(54) SYSTEM AND METHOD FOR STORE LEVEL LABOR DEMAND FORECASTING FOR LARGE RETAIL CHAIN STORES

(71) Applicants: Kiran Kumar SINGH, Gurgaon (IN); Saktipada MAITY, Kolkata (IN); Amit DHALL, Ambala (IN)

(72) Inventors: Kiran Kumar SINGH, Gurgaon (IN); Saktipada MAITY, Kolkata (IN); Amit DHALL, Ambala (IN)

(21) Appl. No.: 13/466,157

(22) Filed: May 8, 2012

(30) Foreign Application Priority Data
Apr. 2, 2012 (IN) 1318/CHE/2012
May 7, 2012 (IN) 1769/CHE/2012

(51) Int. Cl. G06Q 10/06

(52) U.S. Cl. 705/7.25

(57) ABSTRACT

A system and method for store level labor demand forecasting for large retail chain stores are disclosed. In one embodiment, a chain store level labor budget in labor hours for a future point-in-time is determined. Further, backend labor hours are obtained for each store using a backend regression equation that is based on forecasted independent variables. Furthermore, frontend labor hours are obtained for each store using a frontend regression equation that is based on customer service driven factors and using a what if scenario model to select best case values of the customer service driven factors. In addition, needed store level labor hours are obtained for each store by aggregating the obtained backend and frontend labor hours. Moreover, store peer groups are formed and a performance rank of each store within each store peer group is obtained. Also, allocated chain store level labor hours to each store are optimized.

Benefit is claimed under 35 U.S.C 119(a)-(d) to Indian Provisional Application Serial. No. 1318/CHE/2012 entitled “System and method for store level labor demand forecasting for large retail chain stores” filed on Apr. 2, 2012 and Serial. No. 1769/CHE/2012 entitled “System and method for store level labor demand forecasting for large retail chain stores” filed on May 7, 2012 by Wipro Limited.

### TECHNICAL FIELD

Embodiments of the present subject matter relate to labor and workforce management. More particularly, embodiments of the present subject matter relate to a computer implemented system and method for store level labor demand forecasting for large retail chain stores.

### BACKGROUND

Typically, store labor expense is by far the largest component of a retailer's costs after the cost of goods sold, often accounting for about 8 to 20% of sales and sometimes more than 50% of operating costs.

Generally, store labor relates to work done within four walls of a store to manage its operations like trailer unloading, backroom stocking, promotion execution, pricing updates, and also to manage customer service functions like providing products and services advice, cashiering, and other customer facing roles to fulfill customer service expectations. The labor associated with work done at corporate offices, regional offices and distribution centers are outside of the store labor purview.

One existing method for store labor planning uses two broad steps, one being labor budgeting at a chain store level and second being labor forecasting at a store level for all stores. Both the steps are primarily done by a corporate based payroll team in agreement with a corporate finance team. Further, this method is based on the assumption that most of the retailers are preparing store level labor forecasting based on a sales volume. However, any variance between an aggregated store labor forecast and corporate labor hours is rationed at same rate, across the stores, which may lead to sub-optimal allocation, for a particular store or group of stores. Furthermore, the method suggests that there should be consideration for a bottom-up or labor standards based approach, for more realistic labor forecasting.

Some existing methods attempted to generate a labor forecast for a store, based on a sales forecast and historical work effort information. Further, some existing methods recommended labor requirement for a specific period of time by distributing labor as a linear function of a foot traffic volume and user defined work standards. Furthermore, some existing methods even attempt to use service related transactions and activities and convert it to labor requirements by analyzing transaction time and a forecasted number of transactions. Another existing method categorizes a type of work for various service requests and attempts to forecast labor by correlating a quality of service required and forecasted number of service requests.

The above existing methods of using individual planning and manual consolidation may work for chains with fewer numbers of stores. However, for large chain stores, it may lead to an inaccurate labor plan. Some existing methods address workforce estimation, in isolation, for a single store within the enterprise, based on a customer traffic and sales volume. Existing methods are either not aligned to take into consideration overall organization factors (corporate goals) or some of them address the organization factors in a limited way and leave out critical aspects such as budgetary constraints, enterprise-wide labor productivity history and improvement targets, customer ratings, store ratings, and payroll expense rates. Therefore, these techniques can lead to generation of isolated forecasting for each store which may result in an estimation that is not optimized and may not be acceptable from the overall organization point of view, in case of large chain stores. Another pitfall with these isolated methods is, the tolerances in variation of planned versus actual in operation, which may aggregate into massive variation in the performance of the large chain stores as a whole.

### SUMMARY

A system and method for store level labor demand forecasting for large retail chain stores are disclosed. According to one aspect of the present subject matter, a chain store level labor budget in labor hours for a future point-in-time is determined based on a chain store level sales forecast and an available payroll expense rate simulation using chain store level aggregated operational parameters' performance scores, a chain store level aggregated customer satisfaction rating and previous point-in-time consumption of a payroll expense.

Further, backend labor hours are obtained for each store using a backend regression equation that is based on forecasted independent variables. Furthermore, frontend labor hours are obtained for each store using a frontend regression equation that is based on customer service driven factors and using a what if scenario model to select best case values of the customer service driven factors to maintain an optimal payroll margin. In addition, needed store level labor hours are obtained for each store by aggregating the obtained backend and frontend labor hours of each store. For example, store level forecasting is a combination of backend and front end labor hours.

Moreover, store peer groups are formed using performance data and characteristics data of each store and a performance rank of each store within each store peer group is obtained. Also, the allocated chain store level labor hours to each store are optimized based on the obtained performance rank of each store within an associated store peer group, the obtained store level aggregated needed labor hours for each store and the determined chain store level labor budget in labor hours.

According to another aspect of the present subject matter, a store level labor demand forecasting system includes one or more processors, memory coupled to the one or more processors and a labor forecasting and optimization engine residing in the memory. Further, the labor forecasting and optimization engine includes a plurality of programming modules, such as a data acquisition interface module, a correlation module, a forecasting module, a regression module, a what if scenario module, a segmentation module and a labor optimizer module. Furthermore, the one or more processors are associated with the plurality of programming modules.

In addition, the labor optimizer module pre-processes the best available chain store level labor budget in labor hours for the future point-in-time based on the chain store level sales forecast received from the forecasting module, the available payroll expense rate simulation received from the what if scenario module and relationship of the payroll expense rate using the chain store level aggregated operational parameters' performance scores, chain store level aggregated customer satisfaction rating, previous point-in-time consumption of the payroll expense obtained from the regression module and corresponding data support from the data acquisition interface module.

Moreover, the labor optimizer module pre-processes the aggregated needed labor hours for each store by aggregating the backend and frontend labor hours for each store. In one embodiment, the backend labor hours of each store are obtained using the backend regression equation obtained from the regression module that is based on the forecasted independent variables obtained from the forecasting module, key independent variables obtained using the correlation module and corresponding data supported by the data acquisition interface module. Further, the what if scenario module determines best frontend labor hours needed for each store by maximizing a payroll margin using the frontend regression equation received from the regression module that is based on the customer service driven factors obtained from the forecasting module, the key customer service driven factors obtained using the correlation module and corresponding data support from the data acquisition interface module.

Also, the segmentation module forms the store peer groups using the performance data and characteristics data of each store supported by the data acquisition interface module. Further, the labor optimizer module pre-processes the performance rank of each store within each store peer group. Furthermore, the labor optimizer module optimizes the allocated chain store level labor hours to each store using the performance rank of each store within each store peer group, the aggregated backend and frontend needed labor hours, and the chain store level available labor hour budget in labor hours.

According to yet another aspect of the present subject matter, a non-transitory computer-readable storage medium for store level labor demand forecasting for large retail chain stores, having instructions that, when executed by a computing device causes the computing device to perform the method described above.

The system and method disclosed herein may be implemented in any means for achieving various aspects. Other features will be apparent from the accompanying drawings and from the detailed description that follow.

### BRIEF DESCRIPTION OF THE DRAWINGS

Various embodiments are described herein with reference to the drawings, wherein:

FIG. 1 illustrates a flowchart of a method for store level labor demand forecasting for large retail chain stores, according to one embodiment;

FIG. 2 illustrates a flowchart of a method for store peer group benchmarking, according to one embodiment;

FIG. 3 illustrates a flowchart of a method for store labor optimizing, according to one embodiment;

FIG. 4 illustrates a block diagram including major process steps of the method of store level labor demand forecasting for the large retail chain stores, such as shown in FIG. 1, and their sequence of execution, according to one embodiment;

FIG. 5 illustrates a store level labor demand forecasting system for store level labor demand forecasting for the large retail chain stores, using the process described with reference to FIG. 1, according to one embodiment;

FIG. 6 illustrates a block diagram including major components/modules of the store level labor demand forecasting system, such as the one shown in FIG. 5, according to one embodiment;

FIG. 7 is a table showing key functionalities of the major components/modules, such as those shown in FIG. 6, according to one embodiment;

FIG. 8 is a table showing details of the process steps shown in FIG. 4, according to one embodiment;

FIG. 9 is a screen illustrating corporate labor budgeting, according to one embodiment;

FIG. 10 is a screen illustrating backend labor forecasting, according to one embodiment;

FIG. 11 is a screen illustrating frontend labor forecasting, according to one embodiment; and

FIG. 12 is a screen illustrating store labor hour optimization, according to one embodiment.

The drawings described herein are for illustration purposes only and are not intended to limit the scope of the present disclosure in any way.

### DETAILED DESCRIPTION

A system and method for store level labor demand forecasting based on store attributes and business labor budget constraints for large retail chain stores are disclosed. In the following detailed description of the embodiments of the present subject matter, references are made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

The term “large retail chain stores” refers to retail store chains having 100 or more retail stores and/or customer service stores.

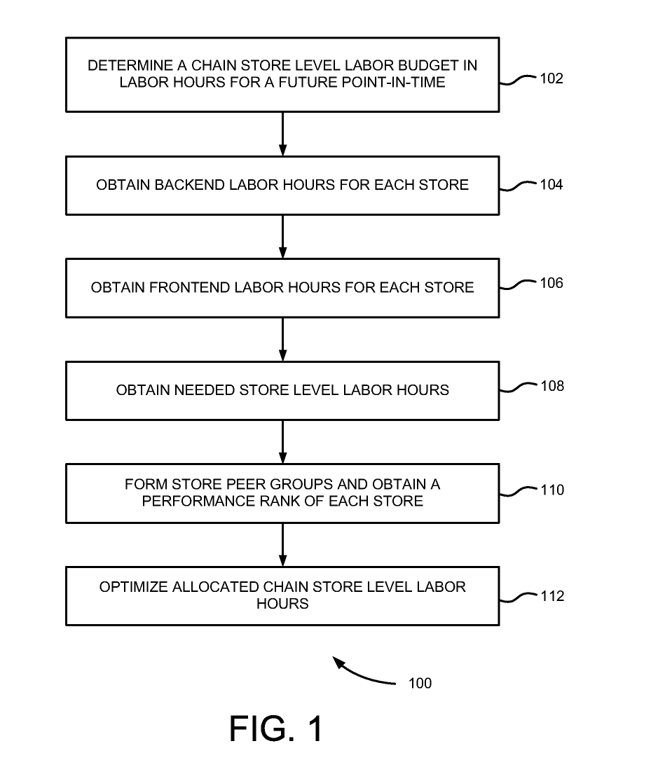

FIG. 1 illustrates a flowchart 100 of a method for store level labor demand forecasting for large retail chain stores, according to one embodiment. At block 102, a chain store level labor budget in labor hours for a future point-in-time is determined based on a chain store level sales forecast and an available payroll expense rate simulation using chain store level aggregated operational parameters' performance scores, a chain store level aggregated customer satisfaction rating and previous point-in-time consumption of a payroll expense. For example, the chain store level aggregated operational parameters include a store operating performance score, a service and fill rate based on a quality of service, an availability of goods and the like. In one embodiment, the chain store level sales forecast for the future point-in-time is determined based on the chain store level aggregated operational parameters' performance scores.

Further in this embodiment, a chain store level available optimized payroll expense rate is obtained using the chain store level aggregated customer satisfaction rating, chain store level aggregated operational parameters' performance scores and previous point-in time consumption of the payroll expense. In one exemplary implementation, a time sliced aggregated chain store level customer satisfaction rating, a store performance score and actual and planned payroll expense rates are collected. Further, a temporal trend of the collected time sliced aggregated chain store level customer satisfaction rating, the store performance score and the actual and planned payroll expense rates are analyzed. Furthermore, a payroll expense rate year to date (YTD) variance is computed based on a difference between planned and actual payroll expense rates YTD. In addition, a correlation value of the payroll expense rate is analyzed with the time sliced aggregated chain store level customer satisfaction rating and the store performance score. Moreover, a correlation value of time sliced payroll expense rate is analyzed with the payroll expense rate YTD variance up to the future point-in-time. Also, a regression equation is formed to estimate the time sliced payroll expense rate as a dependant variable with the time sliced aggregated chain store level customer satisfaction rating, the store performance score and the payroll expense rate YTD variance till the future point-in-time. The chain store level available optimized payroll expense rate for the future point-in-time is then obtained based on a created scenario of the payroll expense rate for the future point-in-time with varied values of the time sliced aggregated chain store level customer satisfaction rating and the store performance score.

Furthermore in this embodiment, a corporate level labor budget is adjusted as a percentage of sales revenue using the obtained chain store level available optimized payroll expense rate. In addition, the chain store level labor budget for the future point-in-time is determined using the chain store level sales forecast and the adjusted corporate level labor budget.

At block 104, backend labor hours are obtained for each store using a backend regression equation that is based on forecasted independent variables. For example, backend factors include store logistics drivers, such as shelf replenishment, store inventory receiving, promotional setups, planogram execution, product pricing setup, a number of received cartons and the like. In one embodiment, a correlation model is developed to select key backend store logistics drivers. Further, a backend forecasting model is developed for predicting futuristic values for each of the selected key backend store logistics drivers. Furthermore, the backend regression equation is developed based on the selected key backend store logistics drivers and associated labor hours. In addition, the backend labor hours are determined for each store using the backend regression equation.

At block 106, frontend labor hours are obtained for each store using a frontend regression equation that is based on customer service driven factors and using a what if scenario model to select best case values of the customer service driven factors to maintain an optimal payroll margin. For example, frontend factors include the customer service driven factors, such as a customer satisfaction rating, waiting time at check-out/cashiering, waiting time in the aisle, sales transaction and the like. In one embodiment, a correlation model is developed to select key customer service driven factors. Further, a frontend forecasting model is developed for selected key customer service driven factors. Furthermore, the frontend regression equation is developed based on the selected key customer service driven factors and associated labor hours. In addition, the what if scenario model is developed to select optimal values for remaining customer service driven factors to achieve a maximum payroll margin. Moreover, the frontend labor hours are estimated for each store using the frontend forecasting model, the optimal values of the remaining customer service driven factors and the frontend regression equation.

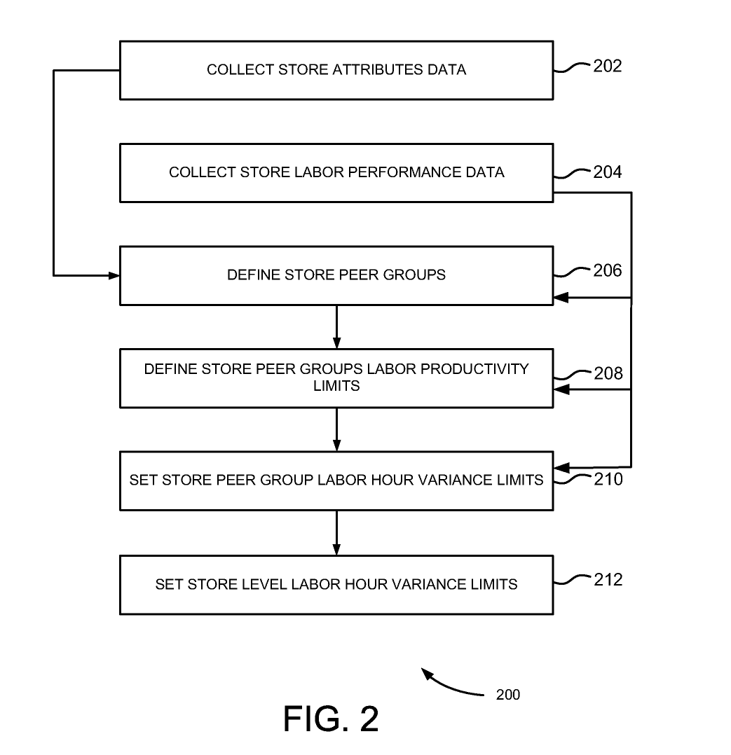

At block 108, needed store level labor hours are obtained for each store by aggregating the obtained backend and frontend labor hours of each store. At block 110, store peer groups are formed using performance data and characteristics data of each store and a performance rank of each store within each store peer group is obtained. In one embodiment, store attributes data is collected for each store. Further, time sliced store performance data is collected for each store. Furthermore, the store peer groups are formed based on the collected store attributes data and time sliced store performance data. In addition, the performance rank of each store within each store peer group is obtained. Moreover, performance limits of each store within each store peer group are obtained. For example, the performance limits are obtained based on performance factors (e.g., a productivity and/or labor hour variance). This is explained in more detail with reference to FIG. 2.

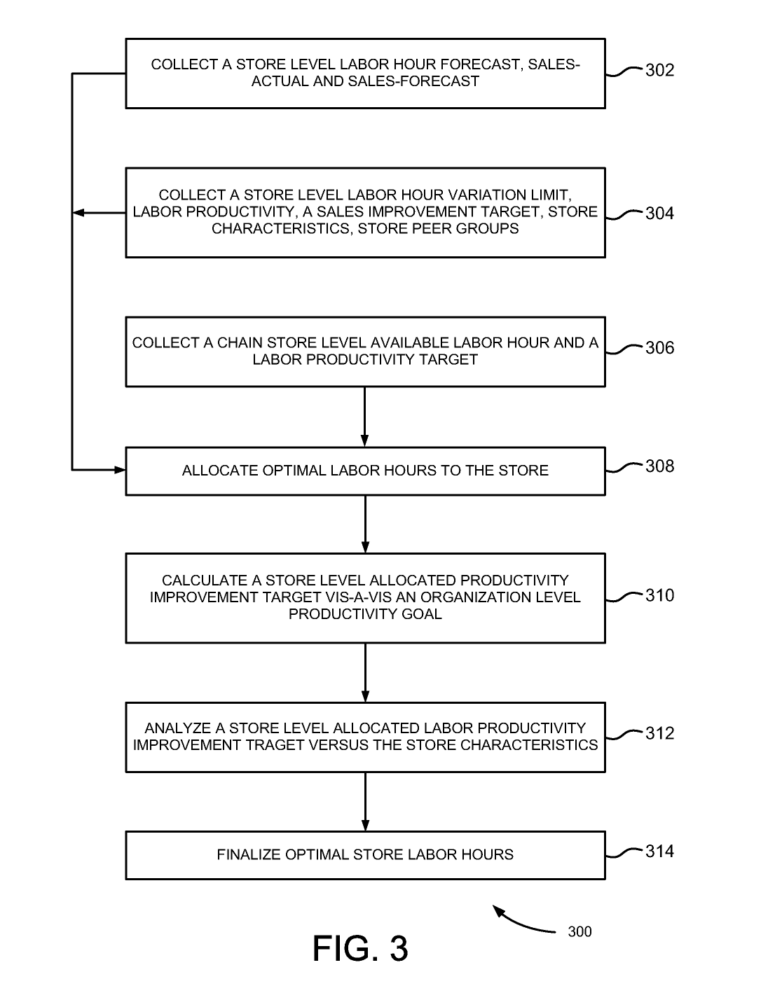

At block 112, allocated chain store level labor hours to each store is optimized based on the obtained performance rank of each store within an associated store peer group, the obtained store level aggregated needed labor hours for each store and the determined chain store level labor budget in labor hours. In one embodiment, optimal labor hours are allocated to each store based on the performance limits of each store within each store peer group until the optimized chain store level labor hours substantially reaches the determined chain store level budget in labor hours. Further, allocated optimal performance is determined based on a productivity and/or labor hour variation improvement target of each store and a store group level benchmarked performance goal to achieve an organization level performance goal and the allocated optimum labor hours to each store are finalized. This is explained in more detail with reference to FIG. 3.

Referring now to FIG. 2, which is a flowchart 200 that illustrates a method for store peer group benchmarking, according to one embodiment. At block 202, store attributes data such as a sales forecast, chain store characteristics, a sales mix, an employee turnover and the like are collected. For example, the store characteristics data includes a type of a chain store, a volume class of the chain store, maturity of the chain store, location of the chain store and the like. For example, the sales mix is defined as a percentage of a transaction mix, a percentage of a material or goods mix, and the like. For example, the employee turnover is defined as percentage new employees within a defined stay at an organization over a total number of employees, a full time employee to a contractor employee mix, and the like. At block 204, time sliced store performance data is collected. Exemplary time sliced store performance data includes labor productivity, labor hour variation and the like. At block 206, store peer groups and a list of stores within each store peer group are defined by analyzing the correlation of the time sliced store performance data versus the store attributes data.

At block 208, the correlation of labor productivity is analyzed by the labor hour variation for each store peer group and labor productivity limits are defined by store peer groups. Further, a performance rank is defined by calculating labor productivity deviation of that chain store from the store peer group average productivity and compared with all store labor productivity deviations. At block 210, store peer group labor hour variation limits are set by using a defined labor productivity limit. At block 212, store level labor hour variance limits are set by mapping to its parent store peer group's labor hour variation limits.

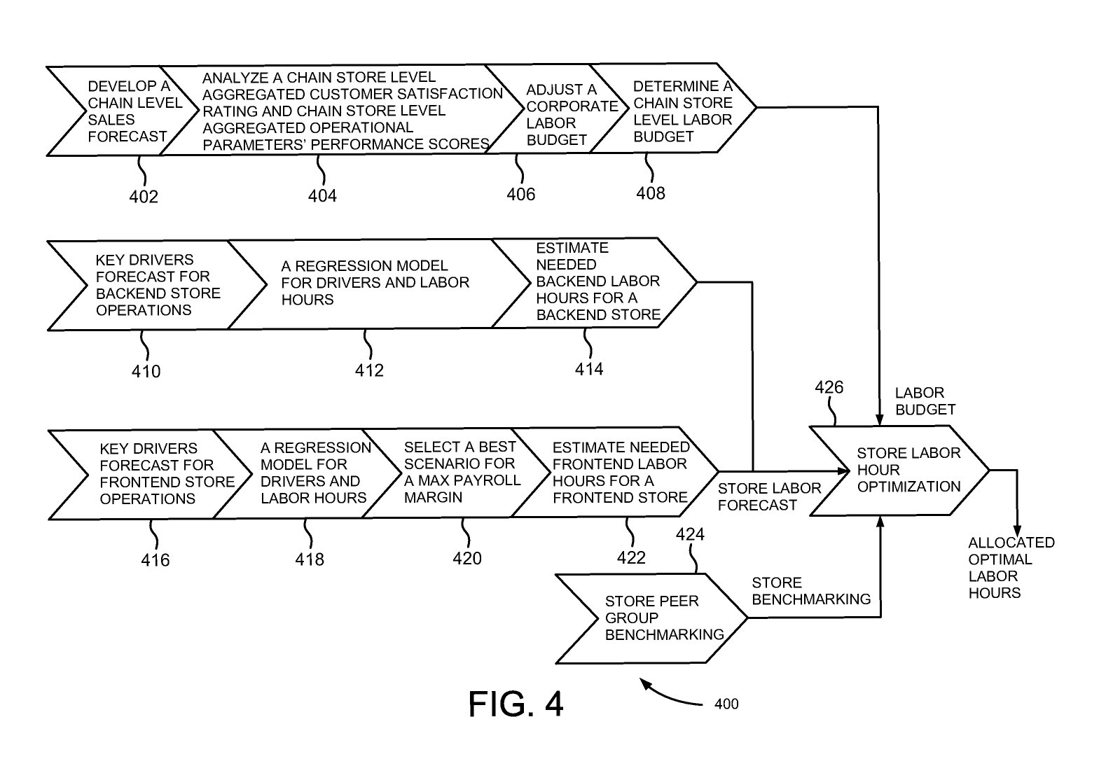

Referring now to FIG. 3, which is a flowchart 300 that illustrates a method for store labor optimizing, according to one embodiment. At block 302, store level total labor hours needed, sales-actual and sale-forecast are collected. This is explained in more detail with reference to FIG. 4. At block 304, store characteristics, store peer groups and a list of stores, performance ranks of each store, labor hour variation limits, a labor productivity and sales improvement target for each store are collected. This is explained in more detail with reference to FIG. 4. At block 306, chain store level available budgeted labor hours and a labor productivity improvement target are collected. This is explained in more detail with reference to FIG. 4.

At block 308, optimal labor hours are allocated to each store. In one embodiment, the labor productivity need for each chain store is calculated based on the sales forecast and total labor hours needed. Further, store level deviation of labor productivity need is calculated from average labor productivity of an associated store peer group. Furthermore, a sales increment target is calculated by each store. In addition, a labor productivity ratio is calculated by each store. For example, the labor productivity ratio is obtained by dividing the store labor productivity need by the chain store level labor productivity target. Moreover, a parameterized optimization model is executed. At block 310, the store level allocated productivity improvement target vis-à-vis an organization level productivity goal is calculated. At block 312, the store level allocated productivity improvement target versus the store characteristics is analyzed. At block 314, optimal store labor hours are finalized.

Referring now to FIG. 4, which illustrates a block diagram 400 including major process steps of the method of store level labor demand forecasting for large retail chain stores, such as shown in FIG. 1, and their sequence of execution, according to one embodiment. At block 402, a chain store level sales forecast is developed. For example, the chain store level sales forecast is developed for entire chain of stores for a future point-in-time based on macro economic factors. At block 404, a chain store level aggregated customer satisfaction rating and chain store level aggregated operational parameters' performance scores are analyzed. In one embodiment, a corporate labor budget is influenced using the chain store level aggregated customer satisfaction rating and chain store level aggregated operational performance scores in order to align with their current performance and future productivity expectations. This is explained in more detail with reference to FIG. 1.

At block 406, the corporate labor budget is adjusted as a percentage of sales revenue using a chain store level available optimized payroll expense rate for the future point-in-time (an output of block 404), expectation on chain store level labor productivity improvement for that time point (as an external input by a chain store level) and a sales forecast for that time point.

At block 408, the chain store level labor budget is determined for the future point-in-time by multiplying values obtained from block 406 and block 402. Further, the chain store level labor budget is converted to chain store level available budgeted labor hours by using a chain store level defined labor wage rate. For example, the chain store level available budgeted labor hours in the future point-in-time is the output of the block 408. Along with the above output, the other inputs/intermediate outputs, such as the chain store level labor productivity improvement target and sales forecast will also be input to store labor optimization.

At block 410, all possible backend workload drivers (backend store logistics drivers) and few key backend workload drivers which are capable of estimating true backend store labor requirement are analyzed. For example, the backend workload drivers include a number of cartons, a number of trailers, a number of push and a number of pull activities, a number of price changes, a number of planogram arranged/re-arranged, and the like. In one embodiment, the backend workload drivers are identified and a time sliced workload driver history for backend store operations are collected. Further, an acceptable value of a correlation coefficient and rules is determined for key backend workload driver selection. For example, key backend workload drivers are selected based on the acceptable correlation coefficient and defined rules. In addition, a backend forecasting model is developed for the selected key backend workload drivers.

At block 412, best backend workload driver regression coefficients and backend intercept, for each store, are estimated using a regressing modeling technique where a time sliced backend labor hour is used as a dependent variable and the key backend workload drivers as independent variables.

At block 414, needed backend labor hours for a backend process are estimated, for each store, using the backend workload driver regression coefficients, backend intercept, and the key backend workload drivers forecast. In one embodiment, the key backend workload drivers forecast, backend workload driver regression coefficients and back end intercept are collected. Further, the needed backend labor hours are calculated using the collected key backend workload drivers forecast, backend workload driver regression coefficients and back end intercept. For example, the needed backend labor hours are needed store level backend labor hours for the future point-in-time.

At block 416, all possible customer service driven factors are analyzed and few key customer service driven factors which are capable of estimating true frontend store labor requirement are selected. For example, the key customer service driven factors include a store level customer satisfaction rating, waiting time in cashiering, sales transaction, and the like. In one embodiment, the customer service driven factors are identified and a time sliced driver history for frontend store operations is collected. Further, an acceptable value of correlation coefficient and rules for the key customer service driven factors selection are determined. Furthermore, the key customer service driven factors are selected based on the acceptable correlation coefficient and defined rules. In addition, a frontend forecasting model is determined for the selected key customer service driven factors.

At block 418, best frontend customer service driver regression coefficients and frontend intercept, for a store, are estimated using a frontend regression equation where the time sliced frontend labor hour is used as a dependent variable and the key customer service driven factors as independent variables.

At block 420, an optimal scenario, for each store, is selected based on a pre-defined range for the key customer service driven factors and a maximization of the future point-in-time payroll margin. For example, the payroll margin is proportional to an operating margin when other cost parameters are not considered or kept constant in the calculation. The inclusion of the customer rating is to ensure that stores are not just focused on the operating margin growth, thereby missing the opportunity to sustain or improve their customer experience and hence improvement in sales and the operating margin. In one embodiment, various scenarios of the payroll margin are created using the relationship between the selected key customer service driven factors, the corresponding frontend labor hours and various values of the key customer service driven factors in a defined range. Further, a best payroll margin scenario which provides the maximum payroll margin for the store within a defined customer service driven factors range is selected. For example, the best payroll margin scenario provides expected values of few key customer service driven factors.

At block 422, frontend labor hours needed, for each store, are estimated using the best payroll margin scenario, customer service driven factor regression coefficients, frontend intercept, and key customer service driven factors forecast/expectation. In one embodiment, the key customer service driven factors forecast/expectation, frontend customer service driver regression coefficients and frontend intercept are collected. Further, frontend labor hours needed is calculated using the values of the key customer service driven factors forecast/expectation, frontend customer service driven factor regression coefficients and frontend intercept. For example, the frontend labor hours needed is store level frontend labor hours needed for the future point-in-time.

At block 424, stores are grouped into clusters based on their common store attributes and benchmark them against the store peer group performance. For example, the stores, which are performing, either too low or too high as compared to their store peer group average are identified. The difference in performance with respect to their store peer group, defines the ranking for each store at the chain level, which in turn is used to reduce (or add) labor hours for the store. This is explained in more detail with reference to FIG. 2.

At block 426, chain store level labor hours are allocated and optimized to each store. In one embodiment, the chain store level available budgeted labor hour, a labor productivity improvement and sales forecast, each store level backend labor hours needed data, each store level frontend labor hours needed data, sales forecast data, store peer groups and a list of stores within each store peer group, a store rank, store level labor hour variance limits data, labor productivity are inputted into an optimization model. Further, the trade-off between chain store level available budgeted labor hour and store level total labor hour need (combination of both backend and frontend store hours) as top down & bottom up constraints, along with store ranking, based on individual store's performance within their store peer group has been performed in the optimization model. For example, the optimization model will consider with an objective to allocate optimum labor hours to each store within the corporate labor hour budget, in a way to minimize the difference between the optimum labor hours and total store labor hours need for each store. This is explained in more detail with reference to FIG. 3.

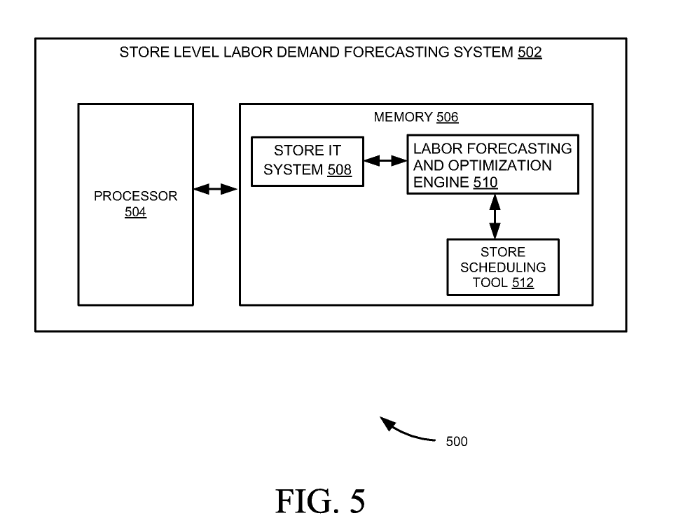

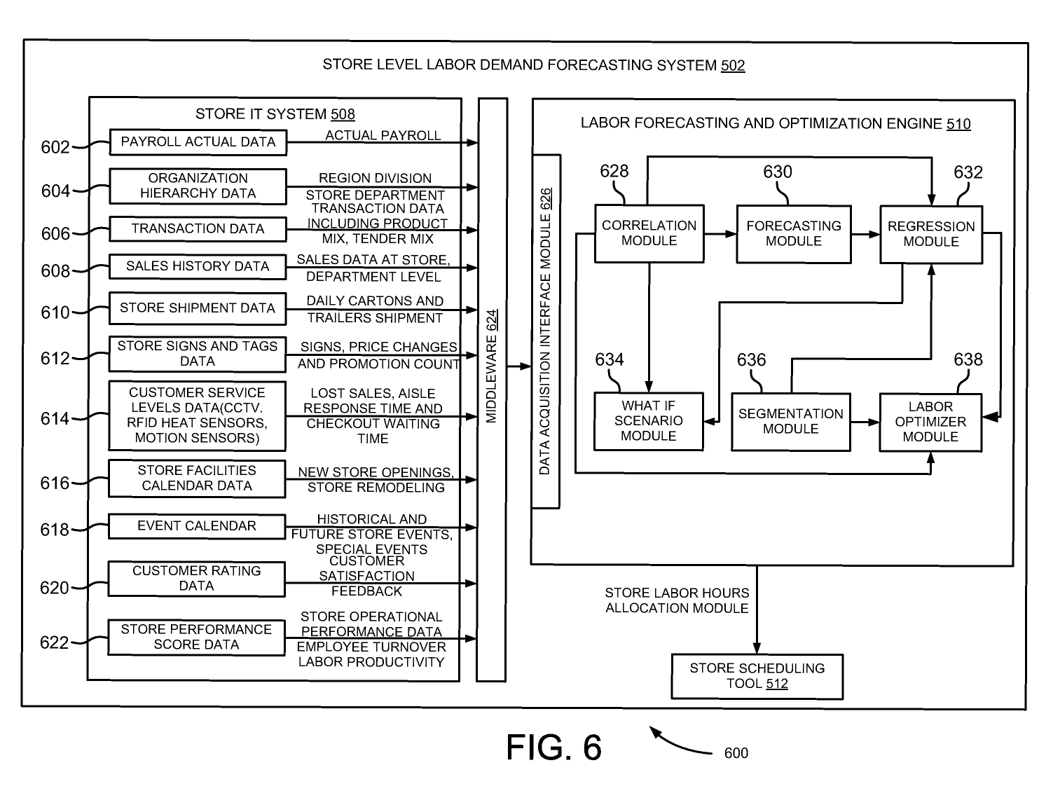

Referring now to FIG. 5, which is a block diagram 500 illustrating store level labor demand forecasting system 502 for store level labor demand forecasting for large retail chain stores, using the process described with reference to FIG. 1, according to one embodiment. As shown in FIG. 5, the store level labor demand forecasting system 502 includes a processor 504, and memory 506. Further, the memory 506 includes a store information technology (IT) system 508, a labor forecasting and optimization engine 510 and a store scheduling tool 512. Furthermore, the memory 504 is coupled to the processor 504. In addition, the store IT system 508 and the labor forecasting and optimization engine 510 are communicatively coupled to each other. Also, the labor forecasting and optimization engine 510 and the store scheduling tool 512 are communicatively coupled to each other. Moreover, the labor forecasting and optimization engine 510 forecasts the store level labor demand for the large retail chain stores using the data obtained from the store IT system 508. This is explained in more detail with reference to FIG. 6.

Referring now to FIG. 6, which illustrates a block diagram 600 including major components/modules of the store level labor demand forecasting system 502, such as the one shown in FIG. 5, according to one embodiment. As shown in FIG. 6, the store level labor demand forecasting system 502 includes the store IT system 508, the labor forecasting and optimization engine 510, the store scheduling tool 512 and a middle ware 624. Further, the store IT system 508 includes payroll actual data 602, organization hierarchy data 604, transaction data 606, sales history data 608, store shipment data 610, store signs and tags data 612, customer service levels data 614, store facilities calendar data 616, an event calendar 618, customer rating data 620, and store performance score data 622. Furthermore, the labor forecasting and optimization engine 508 includes a plurality of programming modules, such as a data acquisition interface module 626, a correlation module 628, a forecasting module 630, a regression module 632, a what if scenario module 634, a segmentation module 636 and a labor optimizer module 638. In addition, major input to the labor forecasting and optimization engine 510 is time sliced data/information.

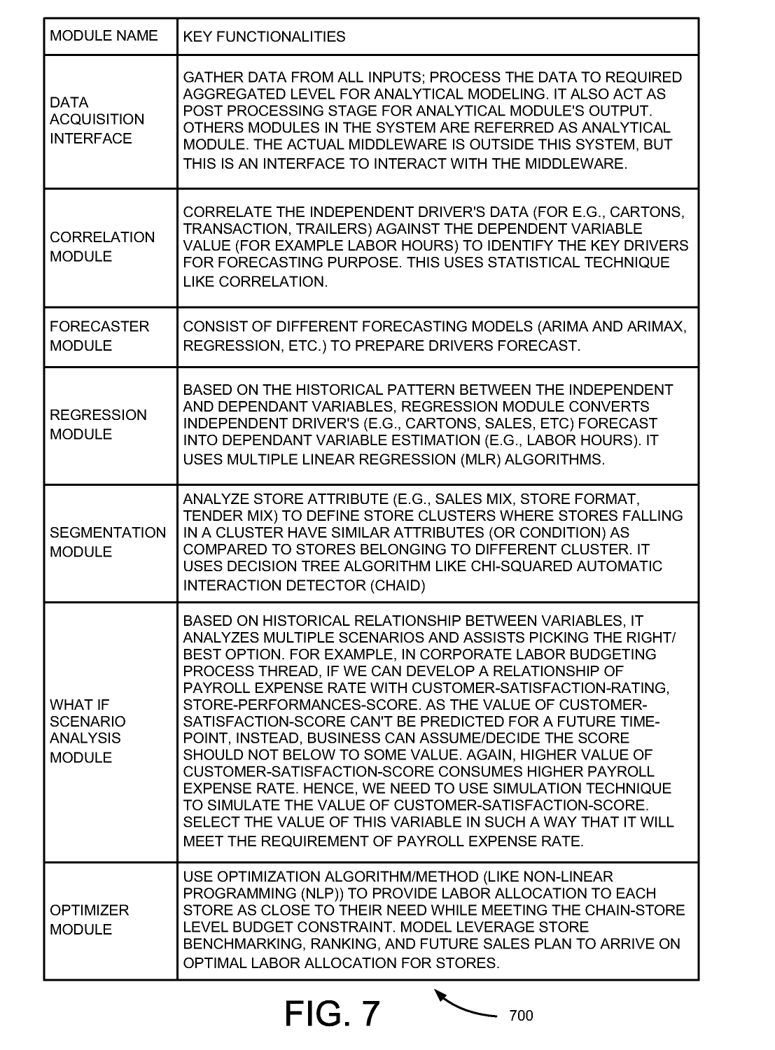

Moreover, the labor forecasting and optimization engine 510 will interface with store IT system 508 via the middleware 624. Also, the correlation module 628 is coupled to the regression module 632, what if scenario module 634, forecasting module 630, and labor optimizer module 638. Further, the forecasting module 630 is coupled to the regression module 632. Furthermore, the regression module 632 is coupled to the labor optimizer module 638 and the what if scenario module 634. In addition, the segmentation module 636 is coupled to the labor optimizer module 638 and regression module 632. Also, the key functionalities of the above modules are explained in more detail with reference to FIG. 7. For example, the data/information from store IT system 508 may be uploaded through a batch mode or a transaction mode via flat files.

Moreover, the interface between the store IT system 508 and labor forecasting and optimization engine 510 includes transfer of the actual payroll from the payroll actual data 602 and region, division, store, department, and the like for defining store characteristics from the organization hierarchy data 604. Further, the interface between the store IT system 508 and labor forecasting and optimization engine 510 includes transfer of the transaction data including tender mix, product mix, and the like from the transaction data 606 and sales data at store and department level from sales history data 608. Furthermore, the interface between the store IT system 508 and labor forecasting and optimization engine 510 includes transfer of the daily cartons, trailers shipment, and the like from the store shipment data 610 and signs, price changes, promotional event counts and the like from the store's signs and tags data 612.

In addition, the interface between the store IT system 508 and labor forecasting and optimization engine 510 includes transfer of the lost sales, checkout waiting time, aisle response time and the like from the customer service levels data 614 and new store opening and store remodeling data from the store facility calendar data 616. Moreover, the interface between the store IT system 508 and labor forecasting and optimization engine 510 includes transfer of the historical, future store events and special events from the event calendar 618, customer satisfaction feedback from the customer rating data 620 and store operational performance data, employee turnover and labor productivity from the store performance score data 622.

In one exemplary implementation, the labor optimizer module 638 pre-processes a best available chain store level labor budget in labor hours for a future point-in-time based on a chain store level sales forecast from the forecasting module 630, an available payroll expense rate simulation received from what if scenario module 634 and relationship of a payroll expense rate using chain store level aggregated operational parameters' performance scores, a chain store level aggregated customer satisfaction rating and previous point-in-time consumption of a payroll expense obtained from the regression module 632.

In one embodiment, the what if scenario module 634 obtains a chain store level available optimized payroll expense rate using the chain store level aggregated customer satisfaction rating, the chain store level aggregated operational parameters' performance scores and previous point-in-time consumption of the payroll expense. For example, the chain store level aggregated operational parameters include store operating performance score, a service and fill rate based on a quality of service, an availability of goods and the like.

In one example, the data acquisition interface module 626 collects a time sliced aggregated chain store level customer satisfaction rating, a store performance score and actual and planned payroll expense rates. Further in this example, the regression module 632 analyzes a temporal trend of the collected time sliced aggregated chain store level customer satisfaction rating, the store performance score and the actual and planned payroll expense rates. Furthermore in this example, the regression module 632 computes a payroll expense rate year to date (YTD) variance based on a difference between planned and actual payroll expense rates YTD. In addition, the regression module 632 analyzes a correlation value of the payroll expense rate with the time sliced aggregated chain store level customer satisfaction rating and the store performance score and further analyzes a correlation value of time sliced payroll expense rate with the payroll expense rate YTD variance up to the future point-in-time.

Moreover, the regression module 632 forms a regression equation to estimate the time sliced payroll expense rate as a dependant variable with the time sliced aggregated chain store level customer satisfaction rating, the store performance score and the payroll expense rate YTD variance till the future point-in-time. Also, the what if scenario module 634 obtains the chain store level available optimized payroll expense rate for the future point-in-time based on a created scenario of the payroll expense rate for the future point-in-time with varied values of the time sliced aggregated chain store level customer satisfaction rating and the store performance score.

Further in this embodiment, the labor optimizer module 638 adjusts a corporate level labor budget as a percentage of sales revenue using the chain store level available optimized payroll expense rate obtained via what if scenario module 634. Furthermore, the labor optimizer module 638 determines the chain store level labor budget for the future point-in-time using the chain store level sales forecast and the adjusted corporate level labor budget.

Further in this implementation, the labor optimizer module 638 obtains backend labor hours for each store using a backend regression equation obtained from the regression module 632 that is based on forecasted independent variables obtained from the forecasting module 630, key independent variables are obtained using the correlation module 628 and corresponding data supported by the data acquisition interface module 626. For example, the backend factors include backend store logistics drivers are obtained via the data acquisition interface module 626 and the backend store logistics drivers include shelf replenishment, store inventory receiving, promotional setups, planogram execution, product pricing setup, a number of received cartons and the like. In one embodiment, the correlation module 628 develops a correlation model to select key backend store logistics drivers. Further, the forecasting module 630 develops a backend forecasting model for predicting futuristic values for each of the selected key backend store logistics drivers. Furthermore, the regression module 632 develops the backend regression equation based on the key backend store logistics drivers and associated labor hours. In addition, the regression module 632 determines the backend labor hours needed for each store using the backend regression equation.

Furthermore in this implementation, the what if scenario module 634 determines best frontend labor hours need for each store by maximizing a payroll margin using a frontend regression equation received from the regression module 632 that is based on customer service driven factors obtained from the forecasting module 630, key customer service driven factors obtained using the correlation module 628 and corresponding data supported by the data acquisition interface module 626. For example, the frontend factors include customer service driven factors obtained via the data acquisition interface module 626 and the customer service driven factors include a customer satisfaction rating, waiting time at check-out/cashiering, waiting time in the aisle, sales transaction and the like. In one embodiment, the correlation module 628 develops a correlation model to select key customer service driven factors. Further, the forecasting module 630 develops a frontend forecasting model for the selected key customer service driven factors. Furthermore, the regression module 632 develops a frontend regression equation based on the selected key customer service driven factors and associated labor hours. In addition, the what if scenario module 634 develops a what if scenario model to select optimal values for remaining customer service driven factors to achieve a maximum payroll margin. Moreover, the forecasting module 630, the regression module 632 and the what if scenario module 634 together estimates the frontend labor hours for each store using the frontend forecasting model, the optimal values of the remaining customer service driven factors and the frontend regression equation.

In addition in this implementation, the labor optimizer module 638 obtains the needed chain store level labor hours by aggregating the obtained backend and frontend labor hours of each store. Moreover in this implementation, the segmentation module 636 forms store peer groups using performance data and characteristics data of each store obtained via the data acquisition interface module 626. Also, the labor optimizer module 638 pre-processes a performance rank of each store within each store peer group. In one embodiment, the data acquisition interface module 626 collects store attributes data for each store and then collects time sliced store performance data for each store. Further, the segmentation module 636 forms the store peer groups based on the collected store attributes data and time sliced store performance data. Furthermore, the labor optimizer module 638 pre-processes the performance rank of each store within each store peer group. In addition, the labor optimizer module 638 obtains performance limits of each store within each store peer group based on a productivity and/or labor hour variance.

Also in this implementation, the labor optimizer module 638 optimizes allocated chain store level labor hours to each store based on the performance rank of each store within an associated store peer group, the obtained store level aggregated backend and frontend needed labor hours for each store and the determined chain store level labor budget in labor hours. In one embodiment, the labor optimizer module 638 allocates optimal labor hours to each store based on the performance limits of each store within each store peer group until the optimized chain store level labor hours substantially reaches the determined chain store level budget in labor hours. Further, the labor optimizer module 638 determines the allocated optimal performance based on a productivity and/or labor hour variation improvement target of each store and a store group level benchmarked performance goal to achieve an organizational level performance goal and finalizes the allocated optimum labor hours to each store. Furthermore, the output of the labor optimizer module 638 is sent to the store scheduling tool 512.

Referring now to FIG. 7, which is a table 700 showing key functionalities of the major components/modules, such as those shown in FIG. 6, according to one embodiment. As shown in FIG. 7, in the table 700, the first column shows names of the major components/modules, such as those shown in FIG. 6. Further, the second column illustrates the key functionalities associated with the major components/modules.

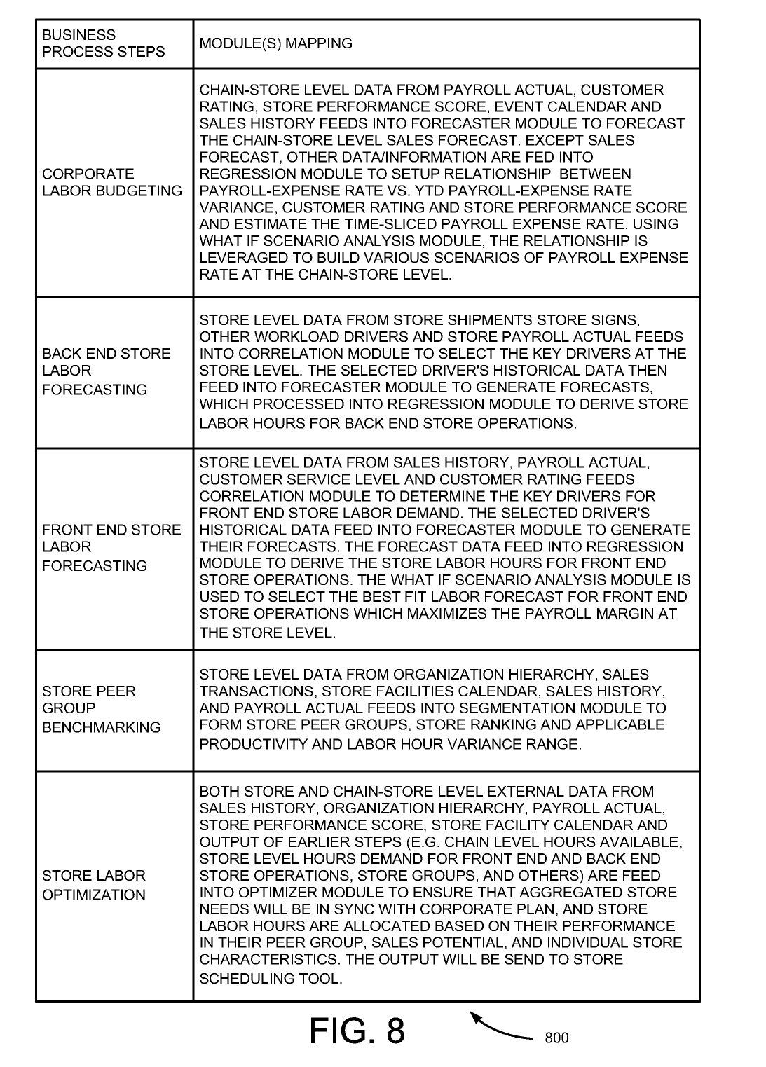

Referring now to FIG. 8, which is a table 800 showing details of the process steps shown in FIG. 4, according to one embodiment. As shown in FIG. 8, in the table 800, the first column shows the business process steps. Further, the second column shows the modules mapping.

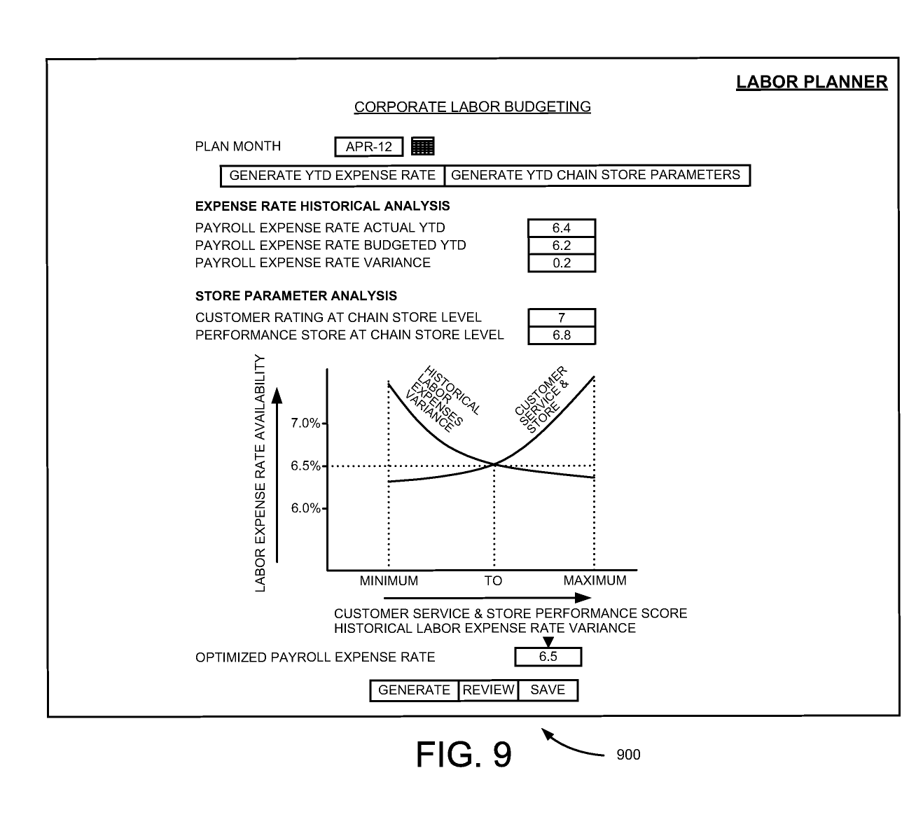

Referring now to FIG. 9, which is a screen 900 illustrating corporate labor budgeting, according to one embodiment. Particularly, the screen 900 illustrates the corporate labor budgeting for April, 2012. Further, the screen 900 illustrates expense rate analysis, store parameter analysis and an optimized payroll expense rate. Furthermore, the screen 900 shows a graph that illustrates a historical labor expenses variance and a customer service and store performance score. As shown in FIG. 9, in the graph, the x-axis indicates the customer service and store performance score and historical labor expense rata variance. Further, the y-axis indicates the labor expense rate availability.

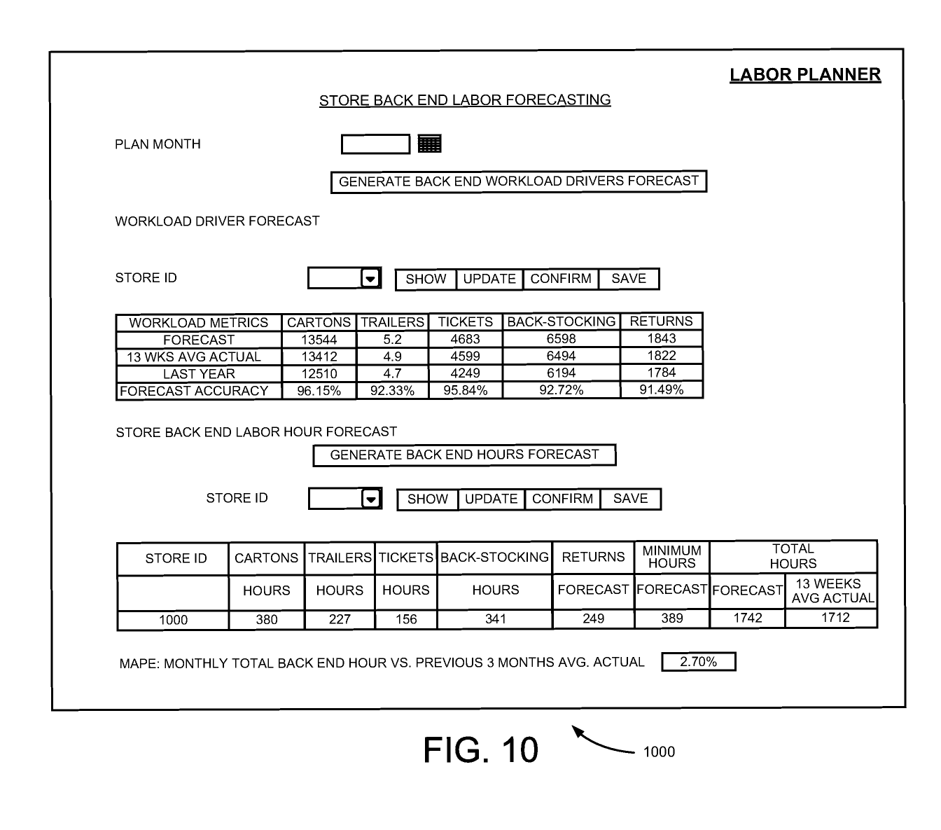

Referring now to FIG. 10, which is a screen 1000 illustrating backend labor forecasting, according to one embodiment. Particularly, the screen 1000 illustrates the generation of a backend workload drivers forecast and backend hours forecast.

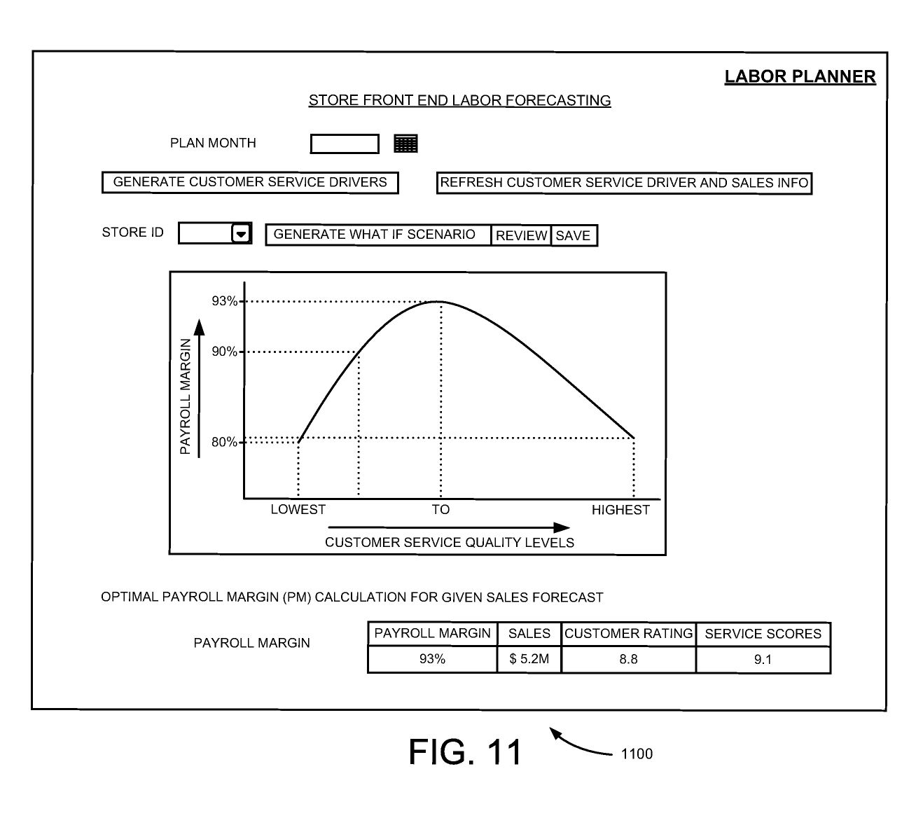

Referring now to FIG. 11, which is a screen 1100 illustrating frontend labor forecasting, according to one embodiment. Particularly, the screen 1100 illustrates the generation of customer service drivers. Further, the screen 1100 shows a graph with a customer service quality level on the x-axis and a payroll margin on the y-axis. Furthermore, the screen 1100 illustrates an optimal payroll margin calculation for given sales forecast.

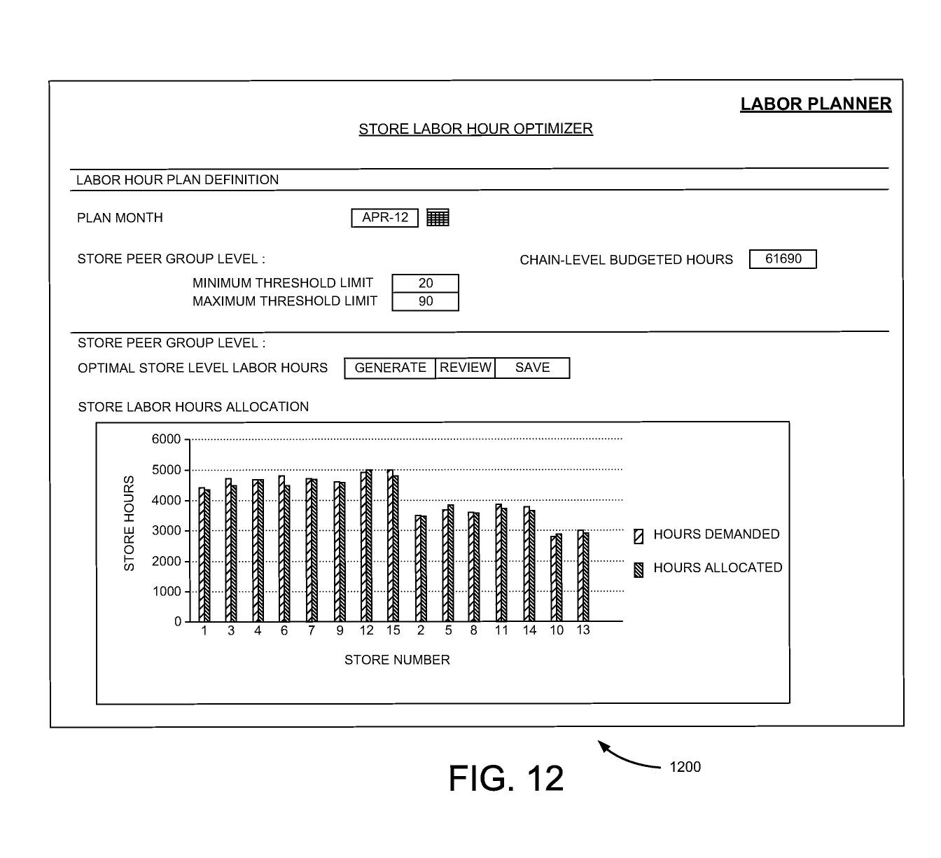

Referring now to FIG. 12, which is a screen 1200 illustrating store labor hour optimization, according to one embodiment. Particularly, the screen 1200 illustrates hours demanded and hours allocated to each store.

In various embodiments, systems and methods described with reference to FIGS. 1 through 12 propose a labor forecasting and optimization engine for store level labor demand forecasting based on store attributes and business labor budget constraints for large retail chain stores. Further, the labor forecasting and optimization engine is used to predict store level forecast based on its workload drivers, customer service impact drivers, and run through optimization model to ensure that corporate and store level budget remain in sync, with optimal allocation to each store based on its attributes and current performance.

Even though the above method and system is described with reference to a large retail chain store, one can envision using this idea for labor planning in businesses, such as banking services, telecom services, airline support services, vehicle maintenance services, chain restaurants, chain hotels, call centers, chain based cruise ships and the like.

Although certain methods, systems, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer implemented method for store level labor demand forecasting for a large retail chain store, comprising:
determining a chain store level labor budget in labor hours for a future point-in-time based on a chain store level sales forecast and an available payroll expense rate simulation using chain store level aggregated operational parameters' performance scores, a chain store level aggregated customer satisfaction rating and previous point-in-time consumption of a payroll expense;
obtaining backend labor hours for each store using a backend regression equation that is based on forecasted independent variables;
obtaining frontend labor hours for each store using a frontend regression equation that is based on customer service driven factors and using a what if scenario model to select best case values of the customer service driven factors to maintain an optimal payroll margin;
obtaining needed store level labor hours for each store by aggregating the obtained backend and frontend labor hours of each store;
forming store peer groups using performance data and characteristics data of each store and obtaining a performance rank of each store within each store peer group; and
optimizing allocated chain store level labor hours to each store based on the obtained performance rank of each store within an associated store peer group, the obtained store level aggregated needed labor hours for each store and the determined chain store level labor budget in labor hours.

2. The computer implemented method of claim 1, wherein the chain store level aggregated operational parameters are selected from the group consisting of a store operating performance score, a service and fill rate based on a quality of service, and an availability of goods.

3. The computer implemented method of claim 1, wherein determining the chain store level labor budget for the future point-in time comprises:
determining the chain store level sales forecast for the future point-in-time based on the chain store level operational parameters' performance scores;
obtaining a chain store level available optimized payroll expense rate using the chain store level aggregated customer satisfaction rating, chain store level aggregated operational parameters' performance scores and previous point-in time consumption of the payroll expense;
adjusting a corporate level labor budget as a percentage of sale revenue using the obtained chain store level available optimized payroll expense rate; and
determining the chain store level labor budget for the future point-in-time using the chain store level sales forecast and the adjusted corporate level labor budget.

4. The computer implemented method of claim 3, wherein obtaining the chain store level available optimized payroll expense rate comprises:
collecting a time sliced aggregated chain store level customer satisfaction rating, a store performance score and actual and planned payroll expense rates;
analyzing a temporal trend of the collected time sliced aggregated chain store level customer satisfaction rating, the store performance score and the actual and planned payroll expense rates;
computing a payroll expense rate year to date (YTD) variance based on a difference between planned and actual payroll expense rates YTD;
analyzing a correlation value of the payroll expense rate with the time sliced aggregated chain store level customer satisfaction rating and the store performance score;
analyzing a correlation value of a time sliced payroll expense rate with the payroll expense rate YTD variance up to the future point-in-time;
forming a regression equation to estimate the time sliced payroll expense rate as a dependant variable with the time sliced aggregated chain store level customer satisfaction rating, the store performance score and the payroll expense rate YTD variance till the future point-in-time; and
obtaining the chain store level available optimized payroll expense rate for the future point-in-time based on a created scenario of the payroll expense rate for the future-point-in-time with varied values of the time sliced aggregated chain store level customer satisfaction rating and the store performance score.

5. The computer implemented method of claim 1, wherein backend factors comprise backend store logistics drivers selected from the group consisting of shelf replenishment, store inventory receiving, promotional setups, planogram execution, product pricing setup and a number of received cartons.

6. The computer implemented method of claim 5, wherein obtaining the backend labor hours for each store using the backend regression equation that is based on the forecasted independent variables comprises:
developing a correlation model to select key backend store logistics drivers;
developing a backend forecasting model for predicting futuristic values for each of the selected key backend store logistics drivers;
developing the backend regression equation based on the selected key backend store logistics drivers and associated labor hours; and
determining the backend labor hours for each store using the backend regression equation.

7. The computer implemented method of claim 1, wherein frontend factors comprise the customer service driven factors selected from the group consisting of a customer satisfaction rating, waiting time at check-out/cashiering, waiting time in the aisle, and sales transaction.

8. The computer implemented method of claim 7, wherein obtaining the frontend labor hours for each store using the regression equation that is based on the customer service driven factors and using the what if scenario model to select the best case values of the customer service driven factors to maintain the optimal payroll margin comprises:
developing a correlation model to select key customer service driven factors;
developing a frontend forecasting model for the selected key customer service driven factors;
developing the frontend regression equation based on the selected key customer service driven factors and associated labor hours;
developing the what if scenario model to select optimal values for remaining customer service driven factors to achieve a maximum payroll margin; and
estimating the frontend labor hours for each store using the frontend forecasting model, the optimal values of the remaining customer service driven factors and the frontend regression equation.

9. The computer implemented method of claim 1, wherein forming the store peer groups using the performance data and characteristics data of each store and obtaining the performance rank of each store within each store peer group comprise:
collecting store attributes data for each store;
collecting time sliced store performance data for each store;
forming the store peer groups based on the collected store attributes data and time sliced store performance data;
obtaining the performance rank of each store within each store peer group; and
obtaining performance limits of each store within each store peer group.

10. The computer implemented method of claim 9, wherein the performance limits are obtained based on performance factors selected from the group consisting of productivity and a labor hour variance.

11. The computer implemented method of claim 10, wherein optimizing the allocated chain store level labor hours to each store based on the obtained performance rank of each store within the associated store peer group, the obtained store level aggregated needed labor hours for each store and the determined chain store level budget in labor hours comprises:
allocating optimal labor hours to each store based on the performance limits of each store within each store peer group until the optimized chain store level labor hours substantially reaches the determined chain store level budget in labor hours; and
determining allocated optimal performance based on a productivity and/or a labor hour variation improvement target of each store and a store group level benchmarked performance goal to achieve an organization level performance goal and finalizing the allocated optimum labor hours to each store.

12. At least one non-transitory computer-readable storage medium for store level labor demand forecasting for a large retail chain store, when executed by a computing device, cause the computing device to:
determine a chain store level labor budget in labor hours for a future point-in-time based on a chain store level sales forecast and an available payroll expense rate simulation using chain store level aggregated operational parameters' performance scores, a chain store level aggregated customer satisfaction rating and previous point-in-time consumption of a payroll expense;
obtain backend labor hours for each store using a backend regression equation that is based on forecasted independent variables;
obtain frontend labor hours for each store using a frontend regression equation that is based on customer service driven factors and using a what if scenario model to select best case values of the customer service driven factors to maintain an optimal payroll margin;
obtain needed store level labor hours for each store by aggregating the obtained backend and frontend labor hours of each store;
form store peer groups using performance data and characteristics data of each store and obtain a performance rank of each store within each store peer group; and
optimize allocated chain store level labor hours of each store based on the obtained performance rank of each store within an associated store peer group, the obtained store level aggregated needed labor hours for each store and the determined chain store level labor budget in labor hours.

13. A store level labor demand forecasting system for store level labor demand forecasting for large retail chain stores, comprising:
one or more processors; and
memory, wherein the memory is coupled to the one or more processors, wherein a labor forecasting and optimization engine residing in the memory, wherein the labor forecasting and optimization engine includes a plurality of programming modules, wherein the one or more processors are associated with the plurality of programming modules, wherein the plurality of programming modules includes a data acquisition interface module, a correlation module, a forecasting module, a regression module, a what if scenario module, a segmentation module and a labor optimizer module,
wherein the labor optimizer module pre-processes a best available chain store level labor budget in labor hours for a future point-in-time based on a chain store level sales forecast received from the forecasting module, an available payroll expense rate simulation received from the what if scenario module and relationship of a payroll expense rate using chain store level aggregated operational parameters' performance scores, a chain store level aggregated customer satisfaction rating, previous point-in-time consumption of a payroll expense obtained from the regression module and corresponding data supported by the data acquisition interface module,
wherein the labor optimizer module obtains backend labor hours for each store using a backend regression equation obtained from the regression module that is based on forecasted independent variables obtained from the forecasting module, key independent variables obtained using the correlation module and the corresponding data supported by the data acquisition interface module,
wherein the what if scenario module determines best frontend labor hours needed for each store by maximizing a payroll margin using a frontend regression equation received from the regression module that is based on customer service driven factors obtained from the forecasting module, key customer service driven factors obtained using the correlation module and the corresponding data supported by the data acquisition interface module,
wherein the labor optimizer module obtains needed chain store level labor hours by aggregating the obtained backend and frontend labor hours of each store,
wherein the segmentation module forms store peer groups using performance data and characteristics data of each store obtained via the data acquisition interface module, and
wherein the labor optimizer module pre-processes a performance rank of each store within each store peer group and further optimizes the allocated chain store level labor hours to each store using the performance rank of each store within an associated store peer group, the obtained store level aggregated backend and frontend needed labor hours for each store and the determined chain store level labor budget in labor hours.

14. The system of claim 13, wherein the chain store level aggregated operational parameters are selected from the group consisting of a store operating performance score, a service and fill rate based on a quality of service, and an availability of goods.

15. The system of claim 13, wherein the what if scenario module obtains a chain store level available optimized payroll expense rate using the chain store level aggregated customer satisfaction rating, a chain store level aggregated operational parameters' performance scores and previous point-in-time consumption of the payroll expense, wherein the labor optimizer module adjusts a corporate level labor budget as a percentage of a sale revenue using the chain store level available optimized payroll expense rate obtained via the what if scenario module, and wherein the labor optimizer module further determines the chain store level labor budget for the future point-in-time using the chain store level sales forecast and the adjusted corporate level labor budget.

16. The system of claim 15, wherein the data acquisition interface module collects a time sliced aggregated chain store level customer satisfaction rating, a store performance score and actual and planned payroll expense rates, wherein the regression module analyzes a temporal trend of the collected time sliced aggregated chain store level customer satisfaction rating, the store performance score and the actual and planned payroll expense rates, wherein the regression module computes a payroll expense rate year to date (YTD) variance based on a difference between planned and actual payroll expense rates YTD, wherein the regression module analyzes a correlation value of the payroll expense rate with the time sliced aggregated chain store level customer satisfaction rating and the store performance score and further analyzes a correlation value of the time sliced payroll expense rate with the payroll expense rate YTD variance up to the future point-in-time, wherein the regression module forms a regression equation to estimate time sliced payroll expense rate as a dependant variable with the time sliced aggregated chain store level customer satisfaction rating, the store performance score and the payroll expense rate YTD variance till the future point-in-time, and wherein the what if scenario module obtains the chain store level available optimized payroll expense rate for the future point-in-time based on a created scenario of the payroll expense rate for the future point-in-time with varied values of the time sliced aggregated chain store level customer satisfaction rating and the store performance score.

17. The system of claim 13, wherein backend factors comprise backend store logistics drivers obtained via the data acquisition interface module and wherein the backend store logistics drivers are selected from the group consisting of shelf replenishment, store inventory receiving, promotional setups, planogram execution, product pricing setup and a number of received cartons.

18. The system of claim 17, wherein the correlation module develops a correlation model to select key backend store logistics drivers, wherein the forecasting module develops a backend forecasting model for predicting futuristic values for each of the selected key backend store logistics drivers, wherein the regression module develops the backend regression equation based on the selected key backend store logistics drivers and associated labor hours, and wherein the regression module determines the backend labor hours needed for each store using the backend regression equation.

19. The system of claim 13, wherein frontend factors comprise the customer service driven factors obtained via the data acquisition interface module and wherein the customer service driven factors are selected from the group consisting of a customer satisfaction rating, waiting time at check-out/cashiering, waiting time in the aisle, and sales transaction.

20. The system of claim 19, wherein the correlation module develops a correlation model to select key customer service driven factors, wherein the forecasting module develops a frontend forecasting model for the selected key customer service driven factors, wherein the regression module develops a frontend regression equation based on the selected key customer service driven factors and associated labor hours, wherein the what if scenario module develops the what if scenario model to select optimal values for remaining customer service driven factors to achieve a maximum payroll margin, and wherein the forecasting module, the regression module and the what if scenario module together estimates the frontend labor hours for each store using the frontend forecasting model, the optimal values of the remaining customer service driven factors and the frontend regression equation.

21. The system of claim 13, wherein the data acquisition interface module collects store attributes data for each store and further collects time sliced store performance data for each store, wherein the segmentation module forms the store peer groups based on the collected store attributes data and time sliced store performance data, wherein the labor optimizer module pre-processes the performance rank of each store within each store peer group, and wherein the labor optimizer module obtains performance limits of each store within each store peer group based on a productivity and/or labor hour variance.

22. The system of claim 21, wherein the labor optimizer module allocates optimal labor hours to each store based on the performance limits of each store within each store peer group until the optimized chain store level labor hours substantially reaches the determined chain store level budget in labor hours and wherein the labor optimizer module determines allocated optimal performance based on a productivity and/or labor hour variation improvement target of each store and a store group level benchmarked performance goal to achieve an organizational level performance goal and finalizes the allocated optimum labor hours to each store.
